(19) United States
(12) Patent Application Publication
(10) Pub. No.: US 2019/0048166 A1
(43) Pub. Date: Feb. 14, 2019

(54) HYBRID PROCESSING OF WASTE MATERIAL

(71) Applicant: Environmental Waste International, Inc., Ajax (CA)

(72) Inventors: Steven L. Kantor, Oshawa (CA); Farzin Rajabi, Toronto (CA); Paul Smith Weinwurm, Oakville (CA)

(21) Appl. No.: 15/676,630

(22) Filed: Aug. 14, 2017

(51) Int. Cl. C08J 11/10; C10G 1/10

(52) U.S. Cl. CPC C08J 11/10; C10G 1/10

(57) ABSTRACT

A system for processing rubber material, the system including a rubber material receiver for accepting the rubber material; a pre-heating unit adapted for the rubber material passing through comprising a plurality of heating elements that heat the rubber material to between 100 to 350 C in an oxygen depleted atmosphere; a microwave unit adapted for receiving the pre-heated rubber material comprising microwave magnetrons, which radiate the pre-heated rubber material in an oxygen depleted environment until the pre-heated rubber is substantially reduced to a carbonaceous material having a volatile content of below 5% and more preferably below 2%; a cooling conveyor that receives processed rubber material from the microwave unit and cools the material in an oxygen depleted environment; and one or more conveyors for transporting the rubber material from the rubber material receiver into and through the pre-heating unit and into and through the microwave unit to the cooling conveyor.

### TECHNICAL FIELD

This invention relates to controlled reduction of organic material, more particularly, rubber based materials using heat and microwave radiation.

### BACKGROUND

There are numerous instances where it is desirable that organic materials be reduced, decomposed or treated. Such a requirement may arise in the processing of raw materials, as, for example, in the extraction of oil from oil shales, or in the treatment of waste materials, such as worn out tires. The accumulation of such materials, for example in landfills or the like, contributes considerably to environmental pollution.

The processing of raw materials and the treatment of waste materials, such as by burning, may itself lead to environmental pollution problems. Furthermore, by-products of non-pyrolytic reduction of organic materials may be valuable as feedstock for other processes. For example, substantial amounts of the major components of tires, namely hydrocarbons (mainly oil and gas), carbon black and steel may be recycled.

Non-pyrolytic reduction of organic material may be accomplished by subjecting the materials to microwave radiation. For example, U.S. Pat. No. 5,877,395 issued Mar. 2, 1999 for a Method and Apparatus for the Controlled Reduction of Organic Material, which is incorporated herein by reference, describes a method and apparatus for the controlled non-pyrolytic reduction of organic material comprising subjecting the material to microwave radiation in a reducing atmosphere.

There is therefore an ongoing need for a more efficient and controllable process for the reduction or decomposition of organic materials.

### BRIEF DESCRIPTION OF THE DRAWINGS

In drawings which illustrate by way of example only various embodiments of the disclosure

FIG. 1 is a block diagram of a hybrid processing system.

FIG. 2 is a schematic diagram of a hybrid processing system.

### DETAILED DESCRIPTION

The system and method described relates to the conversion of tires and other rubber based material into a carbonaceous material by using a combination of heating and use of microwave energy in an oxygen depleted environment. The rubber material may be unvulcanised rubber, also known as green rubber.

The following is offered merely as one possible theory of the operation of the invention, without any representation as to its correctness or applicability. It is believed that microwave energy results in the severing of weaker molecular bonds in longer chain molecules to reduce those molecules to simpler forms. This is in effect a depolymerization process. Microwave energy is absorbed by the organic material, causing an increase in molecular vibration and straining inter-molecular bonds, leading to the generation of narrow band infrared energy. Narrow band infrared energy is re-adsorbed by surrounding material, increasing the amount of energy in the bonds until the bonds break. The breaking of the bonds results in the conversion of complex organic compounds into simpler compounds of lower molecular weight. Depolymerization using microwave energy is much faster than pyrolysis and the conversion from long chain polymers to shorter chain molecules is more extensive. It is believed that pre-heating of the material results in more efficient energy absorption of the microwave energy.

The system may generally be a single unit, either fixed or portable for processing rubber material and generating oils and carbonaceous material. As will be described in more detail, the system may comprise a number of modules. The operation of the modules and the movement of the material through the modules may be controlled by one or more controllers, such as a programmable logic controller or other data processing apparatus. The flow of the material is controlled based on the quantity and quality of the rubber material, the temperature and atmospheric conditions in the pre-heating and microwave units and the output of the processed material through the cooling conveyor. The flow of the material is controlled to maintain the temperatures within appropriate ranges, as described below.

The rubber material may be from used tires or preferably pieces from used tires. Preferably the broken pieces of tire are less than 80 mm in the long dimension. Alternatively, rubber material may be shredded to pieces that may be less than 50 mm, prepared into chips that may be less than 20 mm, or prepared into crumb that may be less than 6 mm. If the internal cavity of a tire is eliminated the smaller rubber pieces may be easier to heat. Smaller pieces may also be easier to heat because of the larger surface area for a given volume. Cut tires may be used where the tires are cut in approximate halves to eliminate the internal cavity.

As the composition of the tires may be different for different manufacturers, using a mix of source rubber material may affect the final composition of the carbonaceous material. As it is preferred to achieve a substantially consistent and homogeneous product in the process, equipment like a multi-stage blending silo may be used to homogenize the finished product. Increased processing may increase the cost of equipment and facility footprint and therefore the overall cost of the process. Using whole tires as feed material may therefore make the process itself more complicated.

Whole tires may be dirty and may require cleaning or washing prior to being processed. Washing whole tires is typically expensive and time consuming. In addition, any washing materials, such as water, may also have to be processed before being discarded. Any water not removed prior to processing of rubber material, may be extracted with the gas emitted during the pre-heating and microwave processing. Having water mixed with the extract gas may make the oil more difficult to condense and separate and result in lower quality oil.

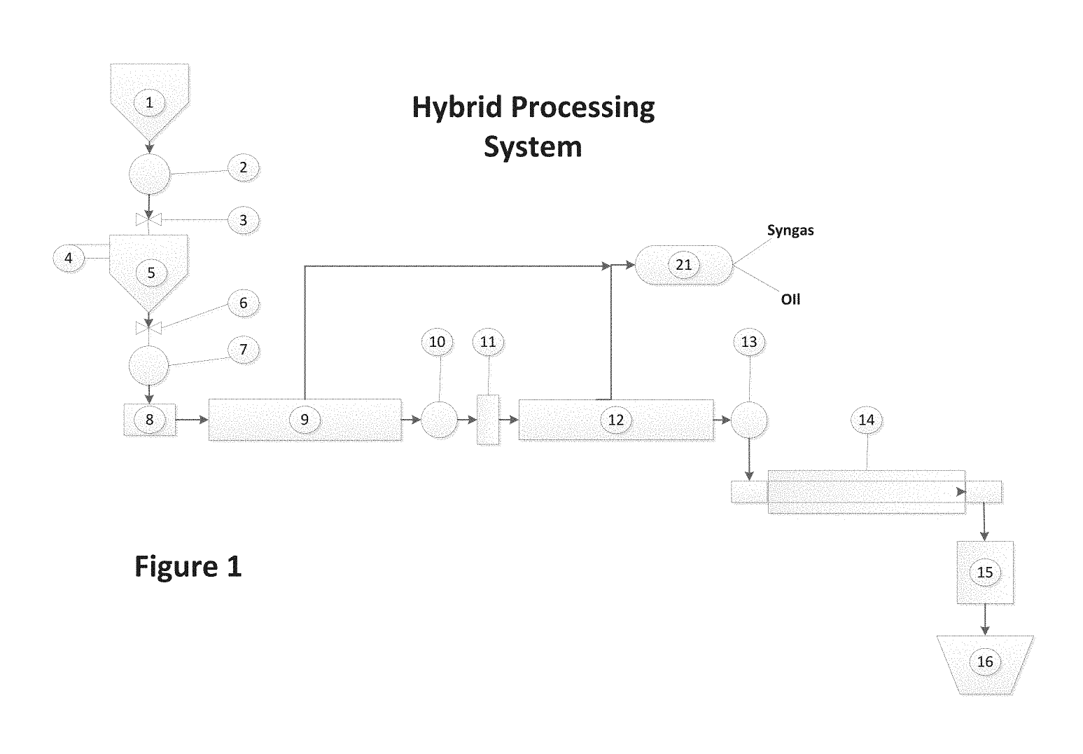

With reference to FIG. 1, material is fed into the system using a material feeding system. Different material feeding systems may be used to feed whole tires or shredded tires. The shredded material feeding system may be a feeding hopper 1, or other input such as a conveyor.

The material is transferred through an isolating unit 2, which isolates the external atmosphere from the other atmosphere inside the further chambers. The isolation unit 2 may be a rotary air lock, a double gate value, slide gate 3 or similar mechanism, or combination of mechanisms. FIG. 1 indicates using both a rotary air lock and a slide gate. The flow of material may be regulated to provide a consistent flow of material through the system. Regulation of the flow of material may be achieved by changing the rotational speed of the rotary airlock, such as by using a variable frequency drive. The flow may be gravity controlled or mechanically controlled by conveyor, augur or similar mechanism.

The material is transferred from hopper 1 into a sealed hopper 5, which may be purged with nitrogen or other inert gas to displace atmospheric oxygen. A level control monitor 4 may monitor the amount of material accumulated in the sealed hopper 5. This may be achieved by stopping the isolation unit 2 when material reaches a determined level in the hopper 5. This hopper 5 may function as a transition hopper. During the purging of atmospheric oxygen, nitrogen or inert gas may be introduced into the hopper while atmospheric air is vented out through a small vent (not shown). The purging process may be initiated by the oxygen level, monitored by an oxygen sensor attached to hopper 5 (not shown). The oxygen level in the hopper 5 may be kept below 3% or preferably below 1.0%. A further isolation unit 7 may be used to seal the hopper atmosphere from the rest of the process. This isolation unit, which might be a rotary airlock or double acting valve controls the flow of material into the processing unit.] In the configuration described above, sealed hopper 5 helps to reduce the amount of inert gas used and improves the control of the oxygen level in the pre heating unit.

Preferably nitrogen or other inert gas is used to purge the atmosphere. Steam is less desirable as a purging material because water condensate may contaminate the hydrocarbons created by the process.

Speed of feeding the rubber material into the buffering unit 8 and consequently into the processing units may be regulated by parameters such as pre-heating temperature and microwave energy capabilities of the system. The source materials may be added intermittently at the feeding hopper 1, for example from a loader or other heavy equipment. The level control monitor 4 may use weight, volume, or other means to determine the amount and flow of the material through the sealed hopper 5 and operate the valves 3 and 6.

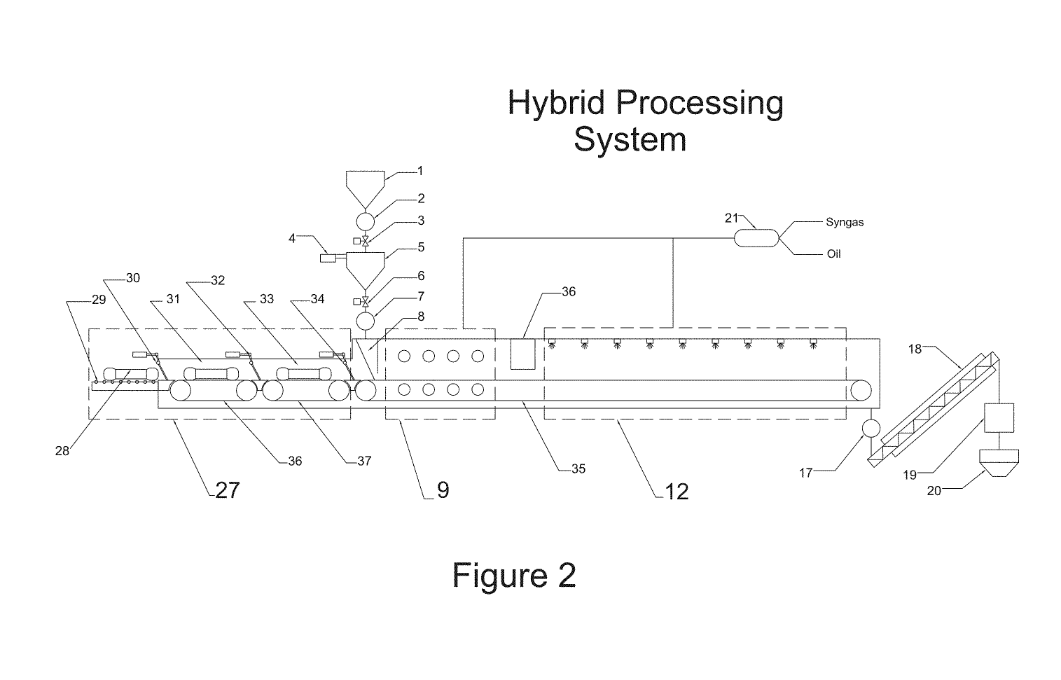

Alternatively, a whole-tire feeding system 27 may be used to supply rubber material to the system. With reference to FIG. 2, a tire feeding conveyor 29 may bring tires 28 into the system. The whole-tire feeding system 27 may include two feeding chambers 31 and 33. With such chambers, tire 28 is fed into chamber 31 through the gate 30 which isolates the chamber 31 from the atmosphere. Gate 30 may be a swing gate or slide gate or any other design, that is substantially air tight. A tire 28 may be transferred into the chamber 31 by a proper conveyor 36 until the tire is in the middle of the chamber 31. At this point, chamber 31 is purged with a shielding gas, such as nitrogen, until the oxygen level is reduced to 10%, preferably to 5%. Gates 30, 32 and 34 are designed to open and close based on a pre-programmed sequence as the tires move through the system. In some embodiments, each chamber 31 and 33 may hold multiple tires rather than a single tire as shown in FIG. 2. Once the oxygen level drops to a desired level in chamber 31, as monitored by chamber atmospheric sensors (not shown), gate 32 may open while gate 30 is closed. Conveyors 36 move the tire 28 from chamber 31 to chamber 33 which has similar conveyor 37. The speeds and operation of conveyors 36 and 37 may be synchronized to facilitate a smooth transition of the tire 28 from chamber 31 to chamber 33. Once the tire 28 reaches to the middle of chamber 33 the gate 32 may close and a second atmospheric purge may take place within chamber 33 to bring down the oxygen level to below 3%, preferably below 1.0% with gate 34 closed. Once the purging process is complete, the gate 34 opens and tire is transferred to pre-heating section to be further processed. Chambers 31 and 33 may both contain tires simultaneously through control of the conveyors and gates. Buffering unit 8 is designed to move to a clear position when the whole tire feeding system is operating.

From the buffering unit 8, the material is transferred, such as by conveyor, through the pre-heating unit 9. Preferably, the materials is moved through the pre-heater unit 9 by way of a conveyor capable of withstanding the heat of the pre-heat unit, such as being made of an appropriate metal. Preferably the flow of material is controlled to maintain a depth of now more than about five centimetres on the conveyor when shredded rubber material is being processed. Having a shallow depth of material aids in the heating of the material in the pre-heating unit.

The pre-heater includes one or more heating elements, such as a radiant heater to heat the material. Preferably the material is heated to approximately 100 C to 350 C. Preferably the material is not combusted and is not heated over 350 C. The material may be heated such that it is not broken down, charred or pyrolized although some material may be decomposed in the pre-heater. Using steam heating is less desirable because water condensation may contaminate the hydrocarbon products created. If the conveyor is metal, heat from the conveyor may also contribute to heating the material.

In some prior art systems, rubber material is heated to temperatures over 600 C. In these systems, very high surface temperatures are required in the heating units for the system to transfer heat, via conduction or convection, to the surface of the material. This only indirectly heats the interior of the rubber material. The high temperatures can damage or reduce the life expectancy of components of the system and result in charring or pyrolysis of the rubber material as well as additional dust.

With regards to the current embodiments, as the materials breakdown in the process there is a release of hydrocarbon vapours which increase the pressure of gases in the tunnel. The tunnel pressure is monitored and the gases are extracted through the condenser and scrubber with a blower or compressor to maintain the set point for tunnel pressure. The atmosphere in the pre-heater, in addition to being oxygen depleted, is preferably maintained just above atmospheric pressure, below 0.2 psi above atmospheric pressure, preferably below 0.1 psi above atmospheric pressure. Maintaining the pressure above ambient atmosphere reduces the amount of oxygen that may enter the system. Higher pressures in the pre-heating unit may be more difficult to maintain because of potential leaks and more complicated isolation units. The same or similar atmospheric conditions may be maintained in both the pre-hating unit and in the microwave unit.

The creation of dust from the material is preferably avoided during the pre-heating, during the transfer to the microwave processing unit and in the microwave processing unit. Agitation of the material, which while it may assist with heating of the material, can cause increased dust. Dust may be contained within the extracted gases requiring additional filtering and extraction to isolate from the gas stream. Preferably, material is not significantly agitated during the processes. Conveyor belts that reduce agitation of the material may be used. A flat conveyor will not generally agitate the material causing the increased dust problem that may arise from auger conveyors used by other processes. The microwave energy does not require agitation to get a good heat transfer. The other methods of heating typically do require agitation for a good heat transfer. Using a metallic conveyor also helps to more uniformly distribute the material, which will result in more uniform processing. Especially for microwave heating, uniform distribution may help to balance the load on magnetrons, the microwave energy source.

The pre-heated material may be transferred to the microwave processing unit by a common conveyor 35. Using a common conveyor throughout the process may help to reduce material agitation and dust creation from the rubber material.

A shielding unit 36 may be included prior to the microwave processing unit 12 to block microwaves from passing into the pre-heater. In an embodiment, the pre-heater, and the conveyor or conveyors, moving material through the pre-heater to the microwave unit are made from a suitable material for traversing both the pre-heating unit and the microwave unit. If the depth of shredded rubber material on the conveyor is low, preferably less than 5 cm, less microwave shielding may be required because of the small opening required for the material and conveyor to pass into the microwave unit. Using a single conveyor traversing both the pre-heating unit and microwave unit may reduce the amount of dust compared to systems requiring the transfer of material from a first conveyor for the pre-heating unit and a second conveyor for the microwave unit.

Using a single conveyor for moving material through the pre-heating and microwave units reduces the build-up of waste material on the system. In systems using augers to move rubber material, significant energy is required to move the material as it gets soft and build-up of waste material can occur on the auger. Since preferably, the rubber material is not physically disturbed once it is on the conveyor and is passing through the pre-heating and microwave units, less energy is required to move the material and less build-up occurs on the conveyor.

In the microwave unit 12, microwaves are directed to the material in an oxygen depleted environment. Preferably, the material is treated by microwaves until carbonaceous material has a volatile content of below 5% and more preferably below 2%.

Lower volatile content in the material after microwave treatment is an indication of a better quality carbonaceous material. It is understood that volatiles are tar like hydrocarbons that are trapped in the micro porous structure of the carbonaceous material. These hydrocarbons often require much higher temperatures to evaporate. In conventional pyrolysis process not using a microwave energy, operators may raise the temperature of the processing vessel to very high temperatures such as 600 C to achieve low volatile levels, which has negative consequences for the equipment and requires more energy.

In microwave heating, as in the present embodiments, the heating process is initiated at molecule levels within carbonaceous material. As described above, the volatiles may be evaporated without requiring the material reach the high temperatures.

Preferably the material has been pre-heated sufficiently that the material readily absorbs the microwave energy. Pre-heating of the material has been found by the applicant to improve the absorption of the microwave energy by the material and therefore improve throughput of material through the system.

Once processed, the material is discharged through a further isolation chamber 17 into a cooling conveyor 18. Carbonaceous material may be extracted from the microwave unit once sufficiently processed.

The cooling conveyor is preferably purged with nitrogen to reduce oxidation of the material from the exposure of the carbonaceous material to oxygen. The cooling conveyor may include a cooling jacket to speed the cooling of the processed material.

Once cooled sufficiently below 200 C preferably below 100 C that the material can be exposed to oxygen, it is preferably delivered to a magnetic separator 19. The magnetic separator may remove wires, iron based contaminants and other magnetic material from the carbonaceous material. The resulting processed material may be transferred elsewhere or processed further, such as being mechanically pulverized.

Gaseous hydrocarbons generated and released during the pre-heating or the microwave processing may be extracted from the pre-heating unit and the microwave unit and provided to a condensing unit 21. The condensing unit cools the gases.

The condensable part of the fumes may become liquid oil. Non-condensable gas may be further purified by scrubbing the gas with sodium hydroxide solution to remove hydrogen sulphide, compressed and stored, such as in a pressure vessel. The non-condensable gas may be burned and used for pre-heating in the system or used as a fuel source for other activities such as creating electricity which can be used back into the process.

Various embodiments of the present invention having been thus described in detail by way of example, it will be apparent to those skilled in the art that variations and modifications may be made without departing from the invention.

1. A system for processing rubber material, the system comprising:
a rubber material receiver for accepting the rubber material;
a pre-heating unit adapted for the rubber material passing through comprising a plurality of heating elements that heat the rubber material to between 100 to 350 C in an oxygen depleted atmosphere;
a microwave unit adapted for receiving the pre-heated rubber material comprising microwave magnetrons, which radiate the pre-heated rubber material in an oxygen depleted environment until the pre-heated rubber is substantially reduced to a carbonaceous material having a volatile content of below 5% and more preferably below 2%;
a cooling conveyor that receives processed rubber material from the microwave unit and cools the material in an oxygen depleted environment; and
one or more conveyors for transporting the rubber material from the rubber material receiver into and through the pre-heating unit and into and through the microwave unit to the cooling conveyor.

2. The system of claim 1 wherein the rubber material comprises tires, cut tires, broken tires, shredded rubber, chipped rubber, or crumb.

3. The system of claim 1 further comprising a plurality of isolation units, isolating the atmosphere of at least the pre-heating unit, microwave unit and the cooling conveyor from the ambient atmosphere wherein an inert gas, preferably nitrogen, is introduced into the pre-heating unit, microwave unit and cooling conveyor to create the oxygen depleted environment.

4. The system of claim 1 wherein the one or more conveyors for transporting the rubber material comprises a single conveyor for transferring material into the pre-heating unit through the pre-heating unit, out of the pre-heating unit, into the microwave unit and out of the microwave unit to the cooling conveyor.

5. The system of claim 1 further comprising a purge system attached to the pre-heating unit and microwave unit that extracts any vapours and gases emitted by the material in the pre-heating and microwave units, the extracted vapours and gases are cooled and condensed.

6. The system of claim 1 further comprising a control valve controlling the rate of rubber material entering the pre-heating unit.

7. A method for processing rubber material comprising:
receiving rubber material, the rubber material comprising cut tires, shredded, crumbled, or chipped rubber;
pre-heating the rubber material in an oxygen depleted atmosphere to between 100 to 350 C;
conveying the pre-heated rubber material to a microwave unit;
microwaving the pre-heated rubber material in an oxygen depleted environment until the pre-heated rubber is substantially reduced to a carbonaceous material having a volatile content of below 5% and more preferably below 2%; and
cooling the processed rubber material in a cooling conveyor below 200 C, preferably below 100 C.

8. The method of claim 7 wherein the rubber material comprises tires, cut tires, broken tires, shredded rubber, chipped rubber, or crumb.

9. The method of claim 7 further comprising isolating the atmosphere of the pre-heating unit from the ambient atmosphere and isolating the atmosphere of the microwave unit from the ambient atmosphere.

10. The method of claim 7 wherein conveying the pre-heated rubber material to a microwave unit comprises using a single conveyor to transfer rubber material while pre-heating the material, to the microwave unit and while microwaving the pre-heated rubber material.

11. The method of claim 9 further comprising isolating the atmosphere of the pre-heating unit from the atmosphere of the microwave unit.

12. The method of claim 9 wherein an inert gas, preferably nitrogen, is introduced into the pre-heating unit, microwave unit and cooling conveyor to create the oxygen depleted environment.

13. The method of claim 7 further comprising extracting any vapours and gases emitted by the pre-heating and microwave units, and cooling and condensing the extracted vapours and gases.

14. The method of claim 7 further comprising controlling the rate of rubber material entering the pre-heating unit using a control valve.
